(19) United States
(12) Patent Application Publication
(10) Pub. No.: US 2008/0279189 A1
(43) Pub. Date: Nov. 13, 2008

(54) Method and System For Controlled Delay of Packet Processing With Multiple Loop Paths

(75) Inventors: Brian C. Smith, Forth Worth, TX (US); Gerald S. Stellenberg, Austin, TX (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: 3COM CORPORATION, Marlborough, MA (US)

(21) Appl. No.: 11/745,307

(22) Filed: May 7, 2007

(51) Int. Cl. H04L 12/56

(52) U.S. Cl. 370/394

(57) ABSTRACT

A method and system for introducing controlled delay of packet processing at a network entity using multiple delay loop paths (DLPs). For each packet received at the network entity, a determination will be made as to whether or not processing should be delayed. If delay is necessary, one of a plurality of DLPs will be selected according to a desired delay for the packet and a path delay determined for each DLP. Upon completion of a DLP delay, a packet will be returned for processing, an additional delay, or some other action. Multiple DLPs may be enabled with packet queues, and may be used advantageously by security devices, such as Intrusion Prevention Systems (and other packet processing platforms) for which in-order processing of packets may be desired or required.

### FIELD OF THE INVENTION

The present invention relates to packet processing in a packet-switched network. In particular, the present invention is directed to a method and system of controlled delay of packet processing using multiple delay loop paths.

### BACKGROUND

Packet-switched networks, such as the Internet, transport data and information between communicating devices in packets that are routed and switched across one or more links that make up a connection path. As packet-switched networks have grown in size and complexity, their role in the critical functioning of businesses, institutions, and organizations has increased dramatically. At the same time, the need to secure networks against sophisticated internal and external attacks in the forms of viruses, Trojan horses, worms, and malware, among others, has correspondingly taken on heightened importance. Consequently, advances in methods and technologies for network security are needed to keep pace with the rising threats.

One approach is Intrusion Detection Systems (IDSs) that can detect network attacks. However, being passive systems, they generally offer little more than after-the-fact notification. A more active approach is Intrusion Prevention Systems (IPSs), which go beyond traditional security products, such as firewalls, by proactively analyzing network traffic flows and active connections while scanning incoming and outgoing requests. As network traffic passes through the IPS, it is examined for malicious packets. If a potential threat is detected or traffic is identified as being associated with an unwanted application it is blocked, yet legitimate traffic is passed through the system unimpeded.

An IPS can be implemented as an in-line hardware and/or software based device that can examine each packet in a stream or connection, invoking various levels of intervention based on the results. Thus in addition to routing and switching operations that networks carry out as they route and forward packets between sources and destinations, an IPS can introduce significant packet processing actions that are performed on packets as they travel from source to destination. Other network security methods and devices may similarly act on individual packets, packet streams, and other packet connections.

In carrying out its functions of protecting a network against viruses, Trojan horses, worms, and other sophisticated forms of threats, an IPS effectively monitors every packet bound for the network, subnet, or other devices that it acts to protect. An important aspect of the monitoring is “deep packet inspection” (DPI), a detailed inspection of each packet in the context of the communication in which the packet is transmitted. DPI examines the content encapsulated in packet headers and payloads, tracking the state of packet streams between endpoints of a connection. Its actions may be applied to packets of any protocol or transported application type. As successive packets arrive and are examined, coherence of the inspection and tracking may require continuity of packet content from one packet to the next. Thus if a packet arrives out of sequence, inspection may need to be delayed until an earlier-sequenced packet arrives and is inspected.

Another important aspect of IPS operation is speed. While the primary function of an IPS is network protection, the strategy of placing DPI in the packet streams between endpoints necessarily introduces potential delays, as each packet is subject to inspection. Therefore, it is generally a matter of design principle to perform DPI efficiently and rapidly.

### SUMMARY

In traversing a network from source to destination, packets may arrive at an IPS out-of-sequence with respect to their original transmission order. When this occurs, it may be desirable to delay, in a controlled manner, the processing of out-of-sequence packets until the in-sequence packets arrive. Under certain operational conditions, it may be possible to predict the latency period between the arrival of an out-of-sequence packet and the later arrival of the adjacent, in-sequence packet. Such predictions could be based, for instance, on empirical measurements observed at the point of arrival (e.g., an IPS or other packet processing platform), known traffic characteristics of incoming (arriving packet) links, known characteristics of traffic types, or combinations of these and other factors. Predicted (or estimated) delay can then be used to match the delay imposed on a given out-of-sequence packet to the predicted arrival of the adjacent, in-sequence packet. By doing so, packet processing that depends on in-order sequencing of packets may be efficiently tuned to properties of the out-of-sequence arrivals encountered by the IPS (or other packet-processing platform).

Accordingly, described herein is a method and system of introducing controlled delay in the processing of packets in a packet-switched data network, the method comprising determining that a packet should be delayed, selecting a delay loop path (DLP) according to a desired delay for the packet, and sending the packet to the selected DLP. The determination that a delay is needed, as well as the selection of DLP according to the desired delay, is preferably based on a property of the packet. In particular, recognizing that a packet has been received out of order with respect to at least one other packet in a communication or connection may be used to determine both that a delay is required, and what the delay should be. There may be other properties of a packet that necessitate controlled delay of processing, as well.

These as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible. For instance, structural elements and process steps can be rearranged, combined, distributed, eliminated, or otherwise changed, while remaining within the scope of the invention as claimed.

### BRIEF DESCRIPTION OF THE DRAWINGS

FIG. 1 is a simplified illustration of out-of-sequence arrival of packet fragments at a packet processing platform in which controlled delay of packet processing using multiple delay loop paths may be carried out.

FIG. 2 illustrates use of multiple delay loop paths for controlled delay of packet processing.

FIG. 3 illustrates an exemplary embodiment of a multiple delay loop paths using multiple packet queues.

FIG. 4 depicts a flowchart that illustrates exemplary operation of controlled delay of packet processing using multiple delay loop paths.

FIG. 5 depicts an exemplary embodiment of controlled delay of packet processing using multiple delay loop paths based on a field-programmable gate array.

### DETAILED DESCRIPTION

The method and system described herein is based largely on introducing controlled delay of packets using a construct called a delay loop path (DLP). More particularly, in order to impose a range of delay sizes (or times) to accommodate a possibly large number of packets and a variety of packet types and delay conditions, multiple delay loop paths are employed. Packets that are determined to have arrived to a packet processing platform (such as an IPS) out of sequence may then be subject to a controlled delay appropriate to the properties of the individual packets. Additionally, other criteria, such as network conditions or routes, may be considered as well in determining the need for and size of a delay.

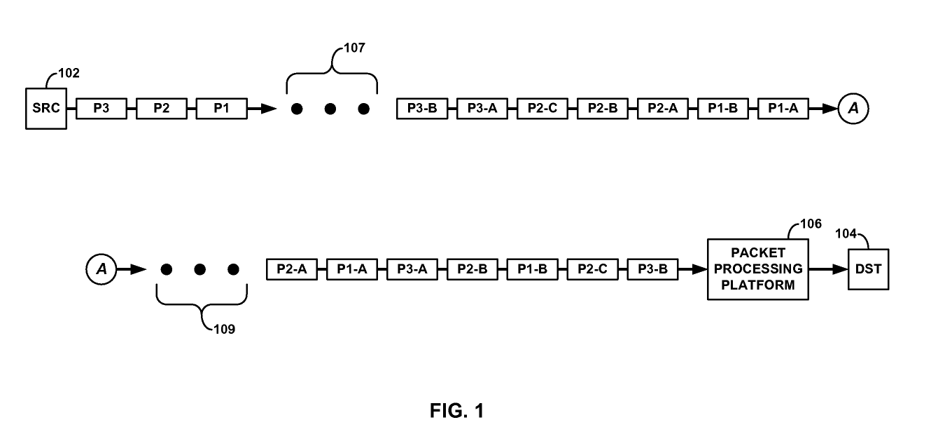

To facilitate the discussion of controlled delay using multiple DLPs, it is useful to first consider a simplified example of network packet transmission that yields out-of-sequence arrival of packets and packet fragments at a packet processing platform. Such a scenario is depicted in FIG. 1. As shown, SRC 102 transmits individual packets “P1,” “P2,” and “P3” in an initial sequence {P1, P2, P3} to DST 104 by way of packet processing platform 106. Note that this packet sequence may represent only a subset of packets associated with a given transmission from SRC 102. For the purposes of the present description, the details of the network (or networks) between SRC 102 and DST 104 are not critical, so all intermediate network elements between SRC 102 and packet processing platform 106 are represented simply as ellipses 107 and 109. Note also that the transmission is depicted in two segments (top and bottom) for convenience of illustration, and that the two circles each labeled “A” simply indicate continuity of the figure between the two segments.

In the exemplary transmission, each packet is fragmented into smaller packets at some point within the network elements represented by ellipses 107, for example at one or more packet routers. The exemplary fragmentation results in packet P1 being subdivided into two packets, designated P1-A and P1-B. Packet P2 is subdivided into three packets, P2-A, P2-B, and P2-C, while packet P3 is subdivided into two packets P3-A and P3-B. As indicated, all of the initial fragments are transmitted in order as sequence {P1-A, P1-B, P2-A, P2-B, P2-C, P3-A, P3-B}. During traversal of the network elements represented by ellipses 109, the order of transmission of the packet fragments becomes altered such that they arrive at packet processing platform 106 out of sequence as {P3-B, P2-C, P1-B, P2-B, P3-A, P1-A, P2-A}, that is, out order with respect to the originally-transmitted fragments. While the cause is not specified in the figure, the re-ordering could be the result of different routers and links traversed by different packet fragments, routing policy decisions at one or more packet routers, or other possible actions or circumstances of the network.

Packet processing platform 106 could be an IPS or other security device, and may require that fragmented packets be reassembled before processing can be carried out. In the exemplary transmission of FIG. 1, packet P3-B must wait for P3-A to arrive before reassembly and subsequent processing can be performed. Similarly, P2-C must wait for P2-B and P2-A, while P1-B must wait for P1-A. In each exemplary instance then, packet processing must be delayed in order to await the arrival of an earlier-sequenced packet. Again, the method and system for controlled delay of packet processing may be advantageously used by packet processing platform 106 to introduce the requisite delay while earlier-arrived, out-of-sequence packets await the arrival of earlier-sequenced packets.

Note that depending upon the particular packet processing carried out, it may or may not be necessary to wait for all fragments of a given packet to arrive before processing begins. For example, it may be sufficient that just pairs of adjacent packet fragments be processed in order. Further, it may not be necessary to actually reassemble packets prior to processing, but only to ensure processing packets or fragments in order. Other particular requirements regarding packet ordering or packet fragment ordering are possible as well. The present invention ensures that delay of packet processing may be introduced in a controlled manner, regardless of the specific details of the processing or the reason(s) for controlled delay.

Controlled Delay of Packet Processing with Multiple Delay Loop Paths

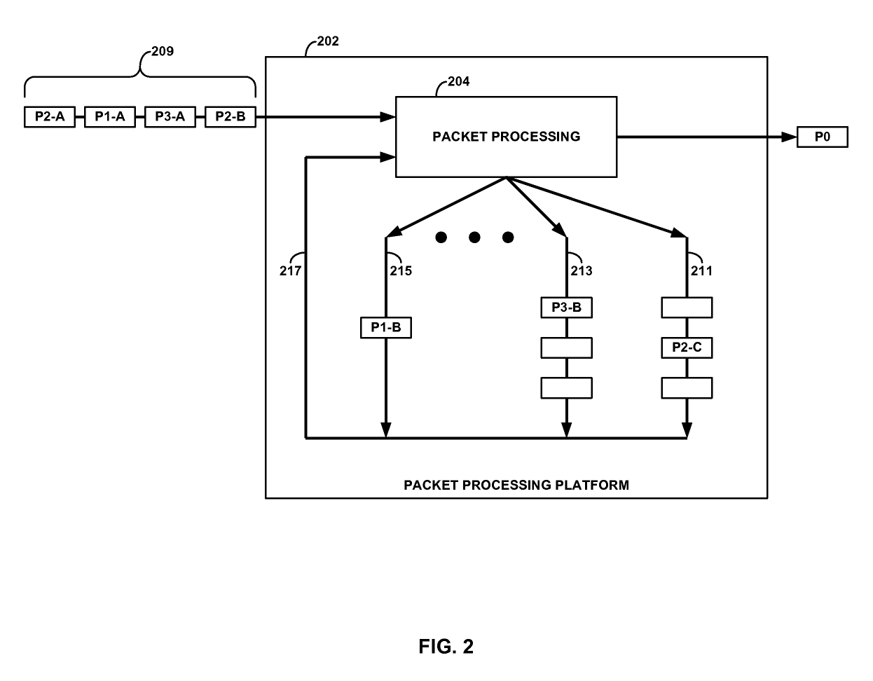

With the out-of-sequence arrival of packets to packet processing platform 106 as an exemplary context, various embodiments of multiple DLPs for controlled delay of packet processing may be described. FIG. 2 illustrates the approach, with packet processing platform 202 corresponding to packet processing platform 106 in FIG. 1, for instance. Packet processing platform 202 comprises packet processing block 204 and multiple DLPs 211, 213, and 215; the horizontal ellipses represent other possible DLPs as well. Each DLP returns packets to packet processing block 204 via DLP exit 217. As indicated by way of example, each of out-of-sequence packet fragments P3-B, P2-C, and P1-B is sent on a different DLP by packet processing block 204. Also by way of example, DLPs 211 and 213 contain other (unlabeled) packets as well. When a given packet, such as P3-B, returns to packet processing block 204 from a DLP, it may find the in-sequence packet for which it was delayed has arrived in the mean time (i.e., P3-A in this example), in which case processing of both packets may then proceed. If instead the awaited, in-sequence packet has still not arrived, then the delayed packet may be subjected to another, possibly different, delay. Alternatively, if an in-sequence packet does not arrive within some pre-defined time, the delayed, out-of-sequence packet may either be discarded, or forwarded to its destination (or next hop) without being processed. Other actions may be applied as well.

In a preferred embodiment, packet processing platform 202 could be an IPS system, and packet processing block 204 could incorporate DPI and other, related security functionality, as well as routine packet receipt and transmission tasks. It should be understood the method and system described herein could apply to other types of packet processing platforms without limiting the scope and spirit of the invention.

Each of a plurality of DLPs could be a physical path or a virtual path within packet processing platform 202, but, in any case, one that functions independently (or largely independently) of packet processing block 204. Each DLP does not significantly impact resources of the packet processing block 202. That is, each imposes a delay on a packet that enters, but the timing resources, and possibly the storage resources, used to yield the delay operate independently and without impacting performance of packet processing block 204.

There are a variety of techniques that may be employed to achieve tuned delay of each of multiple DLPs. In a preferred embodiment, the delay associated with a DLP is comprised of various components. In the following discussion, each component is defined in general terms, with brief examples noted. Later discussions of exemplary embodiments include further descriptions of the delay components in terms of aspects of the embodiments.

Each respective DLP will have an associated path delay that corresponds to the total delay that a given packet would experience if it were sent to the respective DLP. This is the delay that the method and system seeks to impose on a given packet. As an example, the path delay could be the time between placing a packet in a queue and the packet's arrival back to a processing buffer.

Each respective DLP would also have a loop delay, which corresponds to the delay a given packet would experience from entry point to exit point on the respective DLP under the condition that there are no other packets on the DLP when the packet enters. For the example of a queue, the loop delay would correspond to the time it takes for a packet to enter and arrive at the front of the queue assuming the queue were empty when the packet arrived. If the queue operates according to a clock tick, then the loop delay might correspond to the time between ticks.

Additionally, each DLP would have a transit delay, which corresponds to the delay a given packet would experience from entry point to exit point on the respective DLP accounting for all packets (including the given packet) on the DLP when the given packet enters. Again, for the example of a queue, the transit delay would be the loop delay multiplied by the number of packets in the queue when the packet in question arrives.

Finally, each DLP would have a service time, which corresponds to the time it takes a packet to actually exit (or be removed) from the DLP; e.g., the time it takes for a packet to exit the DLP and be received back at packet processing block 204 in the example depicted in FIG. 2. For the example of a queue, the service time could correspond to the time it takes to copy the packet from queue memory to a processing buffer from which the delayed packet processing will resume.

Summarizing then, for a given packet the transit delay of any particular DLP may be computed as the loop delay for the particular DLP multiplied by the number of packets on the particular DLP (including the given packet). The path delay may then be computed as the transit delay plus the service time. As described below, for any particular DLP this formula may further depend on the relative sizes of loop delay and service time.

In a preferred embodiment, a plurality of DLPs is arranged so that the loop delay of each successive DLP is one-half the loop delay of the preceding DLP. According to this configuration, the transit delays of any two DLPs may be the same if the ratio of the number of packets on each respective DLP is inverse to the ratio of the loop delays of each respective DLP. As a specific example, a set of 12 DLPs may be designated as DLPᵢ, i=0, . . . , 11. Each DLP may have a loop delay, tᵢ, given by tᵢ=2⁻ⁱ×t₀, where t₀ is a base loop delay defined for DLP₀. For instance, for t₀=20 ms, the set of 12 DLPs is associated with a corresponding set of (rounded) loop delays given by {(20, 10, 5, 2.5, 1.25) ms; (625, 312.5, 156.2, 78.1, 39, 19.5, 9.7) μs }, where the first five values are in milliseconds (ms) and the last seven are in microseconds (μs).

For this example, a given packet entering DLP₀ under the condition that DLP₀ contains no other packets would see a transit delay of 20 ms. The same transit delay would result for a packet entering DLP₁ if there is already one packet on that DLP₁, or for a packet entering DLP₁₁ if there are already 2,047 packets on DLP₁₁. Similar calculations can be made for the other DLPs as well. At any given time, the distribution of packets across the plurality of DLPs may not necessarily correspond to equal transit delays across DLPs. However, with a plurality of DLPs to choose from, there is a good likelihood that one or more DLPs will have a particular transit delay (or path delay). And as the number of DLPs is increased, so does the likelihood that a DLP with a particular path delay will be available. Further, it is not necessarily required that the same transit delays be applied to all packets. Rather, multiple DLPs offer the ability to select a path delay that is as close as possible to the desired delay for any given packet.

It should be understood that the configuration with 12 DLPs is exemplary, as is the base transit delay of 20 ms. Other arrangements are possible as well, including different numbers of DLPs and different delays. Further, delays need not be multiples of a common base value, and multiple DLPs may yield the same delay values.

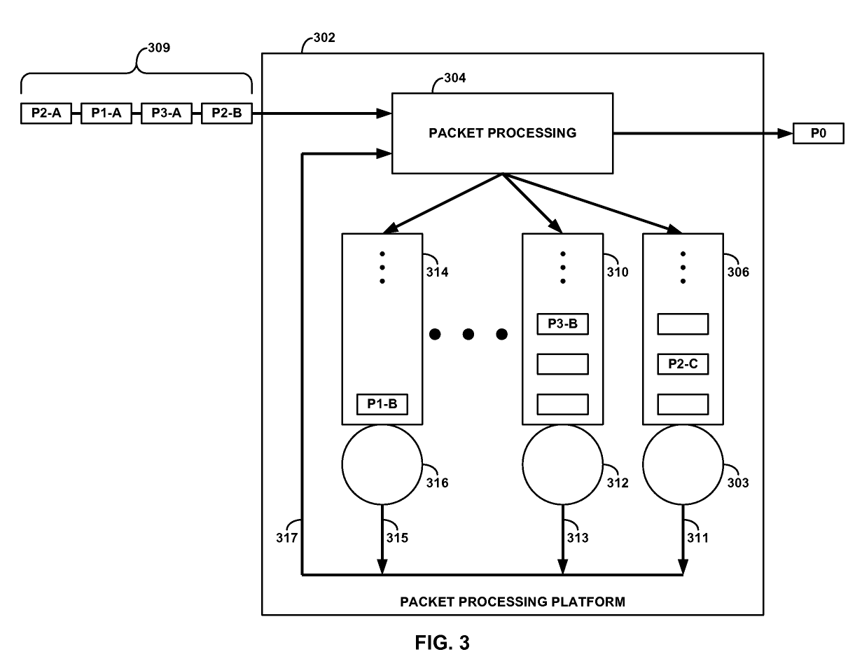

According to another embodiment, multiple DLPs could be implemented in the form of multiple packet queues, as illustrated in FIG. 3. In the arrangement shown, packet processing block 304 may send packets on one of a plurality of queues, represented in the figure as queues 306, 310, and 314; again, the horizontal ellipses indicate that there could be other queues as well. Each of queues 306, 310, and 314 is associated with one of queue servers 308, 312, and 316, respectively, and with one of exits 311, 313, and 315, respectively, which lead to common exit 317. Each queue server could represent an actual service element, or simply just a service time corresponding to removal of a packet from the associated queue. For instance, the service time could correspond to the time required to read a packet from queue memory and copy it to an input port on packet processing block 304 by way of exit 317.

In exemplary operation, as packets are received at processing block platform 304 in packet processing platform 302, each is checked to determine if processing can proceed or if a delay is necessary (i.e., if the packet arrives out-of-sequence, in accordance with the IPS example). As illustrated, a given packet that arrives out of sequence is placed in one of queues 306, 310, or 314 (or possibly one of the queues represented by the horizontal ellipses). In order to select which queue to use, packet processing block 304 preferably determines a desired delay for the given packet, and then determines which of the plurality of packet queues would yield a path delay most closely matched to the desired delay.

The determination of the desired delay could be based on one or more properties of the packet, including, without limitation, packet type (e.g., IP protocol), application type (e.g., application protocol), packet size, sequence number, or fragmentation (if any), to name a few. Additional factors for determining a desired delay could include network conditions, and known or observed characteristics associated with traffic type or other classifications that may be inferred from packet properties. For example, empirical observations of TCP traffic at a packet processing platform may indicate that, with some likelihood, the receipt of any given out-of-sequence packet fragment will be followed by receipt of the in-sequence counterpart within a predictable amount of time. More specifically, some network research suggests that 90% of out-of-sequence TCP packet arrivals are followed by their in-sequence counterparts within 100 ms. Thus if a packet is determined to be part of a TCP connection, and also determined to be out-of-sequence, then the empirical observations indicate that if the packet is delayed for 100 ms following its arrival, there is a 90% likelihood that the in-sequence counterpart will arrive by the time the delay completes. Observed properties for other types of packets could differ from those observed for TCP connections, but may nevertheless be useful in determining delays that may be imposed in a controlled manner.

Other properties of packet that may be used to determine delay may be related to aspects of the application being transported in the packets, or to the particular type of processing that is carried out at the packet processing platform. Alternative embodiments may thus include different algorithms for the determination of desired delay.

The determination of path delay for each queue could be calculated in a manner similar to that described above, or looked up in a table that is dynamically updated according to the current occupancy of the queues, for instance. Path delay for each queue may be further understood by way of example by considering FIFO queues. Each queue may be inspected periodically according to a respective polling cycle, the start of each polling cycle coinciding with the inspection of the respective queue. If a packet is found at the front of a particular queue during inspection, the packet is then removed from the queue and returned to packet processing block 302. When a packet is removed from a queue, all of the remaining packets in the queue are then moved forward. Note that the forward movement could comprise actual movement across queue storage locations or virtual movement corresponding to adjustment of a queue-location pointer (e.g., as in a ring-buffer).

The polling cycle for a queue corresponds to the loop delay defined above, and the time required to remove a packet from a queue and return it for processing corresponds to the service time (e.g., the time required for a memory copy). Assuming the service time for a given queue is shorter than its polling cycle, then packet removal will be complete by the time the next polling cycle begins. In this case, a particular packet entering the given queue will arrive at the front of the queue after a time given approximately by the polling cycle multiplied by the number of packets in the queue (including the particular packet). This waiting time corresponds to the transit delay defined above. (Note that the actual transit delay may also depend on the phase of the polling cycle when a packet enters the queue. For example, the transit delay for a packet that enters a queue at the midpoint of the queue's polling cycle will be shorter by about one-half of a polling cycle than that for a packet that enters at the start of the polling cycle.) Once the particular packet arrives at the front of the queue, it then takes an additional service time before the packet is returned to packet processing block 304. Thus for the given queue, the path delay is determined as the transit time plus the service time.

In accordance with the example above of 12 DLPs, an embodiment of controlled delay could comprise 12 packet queues, Qᵢ, i=0, . . . , 11, and 12 corresponding polling cycles given by {(20, 10, 5, 2.5, 1.25) ms; (625, 312.5, 156.2, 78.1, 39, 19.5, 9.7) μs}, where, again, the first five values are in ms and the last seven are in μs. Assuming all service times are shorter than 9.7 μs, then the transit time for each queue could be calculated as the polling cycle multiplied by the number of packets in the queue. A desired delay of 20 ms for a given packet could be closely attained (i.e., ignoring the assumed-negligible service time) by placing the given packet by itself in the first queue (Q₀), behind one other packet in the second queue (Q₁), behind three other packets in the third queue (Q₂), or behind 2,047 packets in the last queue (Q₁₁), for instance. Any of the other queues could also yield a 20 ms path delay (or close to it), depending on the occupancy of packets. Further, the exemplary configuration of 12 queues and polling cycles could be used to yield other path delays, and there could be more or fewer queues and polling times as well. The present invention is not limited to a specific number of queues, or a specific number and value of polling times and path delays.

Thus, once a desired delay for a packet is determined, a calculation like the one above could be performed for each queue in sequence, followed by selection of the queue with the closest matching path delay. Alternatively, path delay calculations could be continually performed as packets enter and exit the queues. The results could be stored in a look-up table, and the table in turn consulted for each packet that needs to be delayed.

As another example, selection of a path delay may be based on an algorithm that traverses a list of queues (or more generally, DLPs) and chooses the first one for which the path delay is no greater than a certain value. Considering again the 12 exemplary queues and polling cycles described above, an algorithm to select the first queue that yields a path delay of no more than 20 ms (ignoring an assumed-negligible service time) may comprise a logical “case” statement, as represented in the following pseudo-code:

```
Case of:
    Q0_occupancy = 0:
        Enqueue(packet,LoopPath0);
    Q1_occupancy < 2:
        Enqueue(packet,LoopPath1);
    Q2_occupancy < 4:
        Enqueue(packet,LoopPath2);
    Q3_occupancy < 8:
        Enqueue(packet,LoopPath3);
    Q4_occupancy < 16:
        Enqueue(packet,LoopPath4);
    Q5_occupancy < 32:
        Enqueue(packet,LoopPath5);
    Q6_occupancy < 64:
        Enqueue(packet,LoopPath6);
    Q7_occupancy < 128:
        Enqueue(packet,LoopPath7);
    Q8_occupancy < 256:
        Enqueue(packet,LoopPath8);
    Q9_occupancy < 512:
        Enqueue(packet,LoopPath9);
    Q10_occupancy < 1024:
        Enqueue(packet,LoopPath10);
    Q11_occupancy < 2048:
        Enqueue(packet,LoopPath11);
    Else
        Error(loop_path_full);
End Case
```

As the logical cases are traversed for selecting a delay queue for a given packet, for instance in the course of execution of program instructions, the number of packets already in each successively-examined queue is determined in turn (Q0_occupancy, Q1_occupancy, etc.), and the number (implicitly) multiplied by 20 ms. The first case that yields the condition of a path delay no greater than 20 ms triggers the selection of the corresponding queue, according to the “Enqueue” instruction. Any untested cases are then abandoned. The symbolic names for the queues in this example are given as LoopPath0, LoopPath1, and so one. Also in this example, an error is triggered if all of the queues are full. The specific path delays and corresponding case tests could be modified by using different values for polling cycles, for instance.

Note that this exemplary algorithm merely selects the first available queue that yields a delay no greater than 20 ms (base delay). Moreover, alternative algorithms could use a different base delay, or determine a queue selection that yields a specific delay value (or a delay that is closest to a specific value), rather than an upper-limit value.

It should be noted that the assumption that the service time is always smaller than the polling cycle for a queue may not necessarily hold. Service times associated with actual data copy operations will generally vary with packet size, larger packets incurring longer service times. Thus, the service time for a given queue may be more appropriately represented by the average of the service times for all of the packets in the queue. When the average service time for a queue exceeds its respective polling cycle, then loop delay is more accurately represented by the average service time, and the transit delay becomes the average service time multiplied by the number of packets in the queue (this corresponds to the conventional definition for queuing delay). Under these circumstances, the computation of path delay for each queue will preferably take into account the relative sizes of the average service time and the polling cycle for each queue. Further, there may be other circumstances that require additional or alternative methods of path delay computation as well. One skilled in the art will readily recognize that there could be numerous ways to adapt the computation to the particular parameters that apply. The present invention is not limited to one particular form of path delay or path delay computation.

As noted, the description of queuing according to a FIFO discipline is exemplary. Other types of queuing could be employed in the present invention that yield path delays that accommodate the particular range of desired delays expected or required by the packet processing application. Examples include last-in-first-out (LIFO) and priority queues. Moreover, servicing of the queues may be accomplished by methods other than polling cycles. None of these possible variations are limiting with respect to the present invention.

In further accordance with the exemplary embodiment, multiple queues could be implemented in such a way as to minimize the use of processor resources. For instance, the entrance to and exit from each queue could comprise DMA operations. In such an arrangement, data copying involving packets could avoid impacting processor resources associated with programmed data transfer. Further, the polling cycle could be interrupt-driven, wherein each queue might require only one timer. Considering again the example of 12 queues described above, a total of 8,191 packets could be accommodated using just 12 timers if each queue uses just one timer for its polling cycle. One skilled in the art will recognize that other techniques could be used to further reduce the number of timers required. Thus, the multiple DLPs, and multiple queue-based DLPs in particular, make it possible to incorporate in a packet processing platform concurrent controlled delay of processing for a large number of packets in a manner that has minimal impact on the packet processing resources.

Exemplary Operation of Multiple Delay Loop Paths

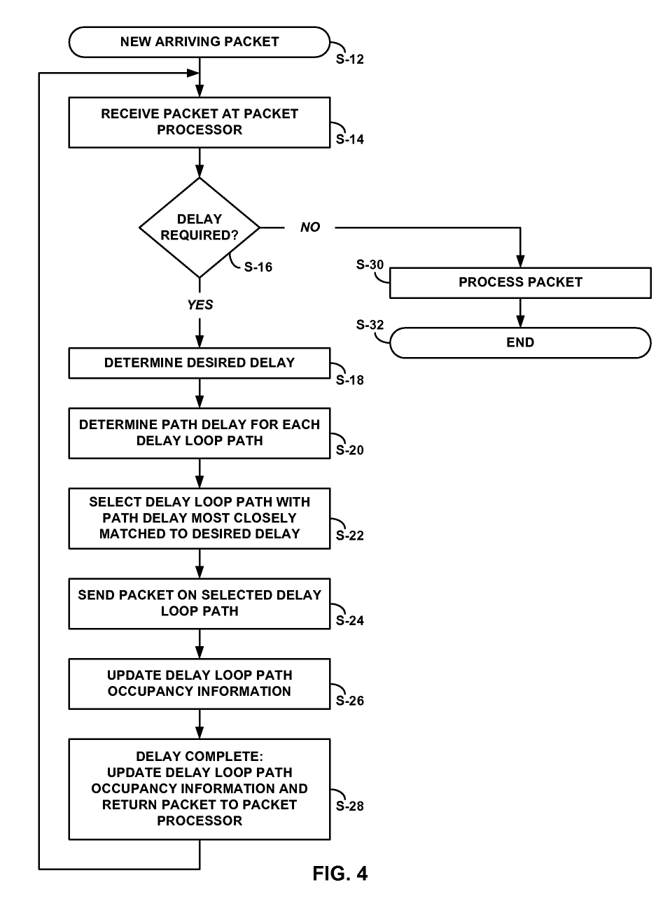

Exemplary operation of multiple DLPs for controlled delay of packet processing is illustrated in FIG. 4 in the form of a flowchart. At step S-12, a new packet arrives at the packet processing platform or system, such as an IPS or other security device. This step is meant to generally represent continuous packet arrivals from the network, including integral packets and packet fragments (as described above), although the flowchart specifies actions carried out on a per-packet basis.

At step S-14, the packet is received at the packet processor, which could be packet processing block 302, for instance. Then, as indicated at step S-16, the packet processor then determines if the packet can be processed immediately or if needs to be delayed. As discussed in the examples above, this determination could be based on whether or not the packet was received in or out of sequence with respect to the original transmission order of packets or packet fragments in the communication. Since step S-14 also applies to packets that are returned to the packet processor following a DLP delay, the decision as to whether or not to delay a packet (step S-16) may also account for the number of DLP delays (if any) the packet has already experienced; this is further discussed below.

If a delay in processing is required, then the packet processor determines a value for the desired delay at step S-18. As discussed above, the desired delay could be based on one or more factors including, without limitation, packet type, transport protocol, application type, fragmentation, and the predicted time until the in-sequence counterpart arrives, among others. The desired delay could also take account of how many previous DLP delays (if any) the packet has already experienced. And again, the determination could additionally account for empirical observations related to the reasons for delay, such as the likelihood of an in-sequence counterpart packet arriving within the delay period of an out-of-sequence packet. Further, empirical or other analyses may indicate dynamical considerations that apply to the factors used to determine desired delay. For instance, the desired delay that applies to out-of-sequence TCP packets might vary with time of day. The scope of the present invention includes any reason for requiring a delay and any value of desired delay, and both may vary on a packet-to-packet basis.

At step S-20, the packet processor determines the path delay for each of the DLPs that are part of the system, and at step S-22 a DLP is selected according to the closest match of its respective path delay to the desired delay. Exemplary arrangements of DLPs and corresponding calculations of their respective path delays have been described above. Note that the exemplary method presented in the pseudo-code does not necessarily compute the path delay for each DLP, but rather traverses a list of DLPs and selects the first one that meets the selection criteria.

At step S-24, the packet is sent on the selected DLP. In the example of multiple queues described above, this action corresponds to placing the packet in the selected queue, possibly via a DMA transfer, for example. The occupancy information for the DLPs is then updated at step S-26. In an exemplary embodiment, a dynamic table is used to track queue occupancy and current path delays. Thus, at step S-26, the table is updated so that the next time a path delay determination is made (i.e., step S-20), the updated table can consulted.

Once the packet delay is complete, the occupancy information is again updated and the packet is returned to the packet processor (step S-28). For a returning packet the process proceeds again from step S-14, but the decision as to whether or not to impose a delay (step S-16) could have a different outcome for a given packet on its second or subsequent visits to the packet processor following a DLP delay. For example, the in-sequence packet (or packet fragment) for which the given packet was delayed may have arrived by the time the given packet returns to the packet processor. Similarly, a packet that is subjected to successive DLP delays may be given a different desired delay value for each one, for instance each successive delay could be shorter than the previous one.

Referring again to step S-16, if the decision is made to not delay the packet, then the packet is processed directly, as indicated at step S-30. The specific processing will preferably correspond to the particular functions and/or tasks of the packet processing platform or system (e.g., an IPS device), and may further depend on whether or not the packet is newly arrived or returning from a DLP delay. For example, packet processing directly following the decision at step S-16 could apply to a newly arrived packet (i.e., from step S-12) that is received in sequence. Note that processing of a packet that arrives in sequence could proceed immediately, or the in-sequence packet could be held while its out-of-sequence counterpart (if any) completes its delay. Other reasons for directly processing a newly arrived packet are possible as well.

Alternatively, as discussed above, packet processing directly following step S-16 could also apply to a packet that has already completed one or more DLP delays. For instance, by the time a DLP delay of an out-of-sequence packet is complete, the packet's in-sequence counterpart may have arrived so that in-sequence processing may proceed. If instead, the in-sequence counterpart does not arrive by the time an out-of-sequence packet completes one or more DLP delays, the out-of-sequence packet could still proceed to processing at step S-30, but in this case processing may amount to discarding the out-of-sequence packet. Other actions are possible as well.

The process for a given packet completes at step S-32 (the possibility of infinitely looping a packet on DLP delays is assumed to be ruled out by some other aspect of the logic not specified in the figure). While step S-32 represents the end of processing for one packet (or an in-order sequence of packets), new packets may arrive according to step S- 12, so that the overall process is continuous.

It should be understood that the flowchart of FIG. 4 is exemplary of operation of controlled delay of packet processing using multiple DLPs. As such, various steps may be modified, and additional or alternative steps could be included while still keeping within the scope and spirit of the present invention.

Exemplary Embodiment Based On a Field-Programmable Gate Array

As mentioned above, an important aspect of certain packet processing platforms or systems, such as IPS and other security devices, is speed. That is, monitoring every packet, e.g., via DPI, in all packet streams and connections that traverse a packet processing platform potentially introduces unwanted delay. Thus it is desirable to carry out packet-inspection operations (or other packet-processing operations) as rapidly as possible. One approach to achieving such processing speed is to implement processing in specialized hardware, such as application-specific integrated circuits (ASICs) and/or field-programmable gate arrays (FPGAs). In such a system, it is further advantageous to implement controlled delay of packet processing using multiple DLPs within the specialized hardware as well. An exemplary FPGA implementation of the present invention is described below.

A typical FPGA comprises a large number of low-level elements physically interconnected on an integrating platform. The low-level elements may each perform simple logical functions that, when sequenced and combined by way of commonly-distributed control signals and/or switched communications between elements, can accomplish complex, but specialized, tasks faster than general purpose processors executing programmed instructions. For instance, certain specialized computations or packet manipulations may be performed more quickly using customized operations of an FPGA than by a general purpose computer.

Modern FPGAs generally also include a number of components that perform higher-level functions that are either common among most general computing devices or at least among a class or classes of devices designed for similar or related purposes. For example, an FPGA device that receives and sends network packets might include an integrated network interface module. Similarly, general data storage may also be included as an integrated module or modules. Other examples are possible as well.

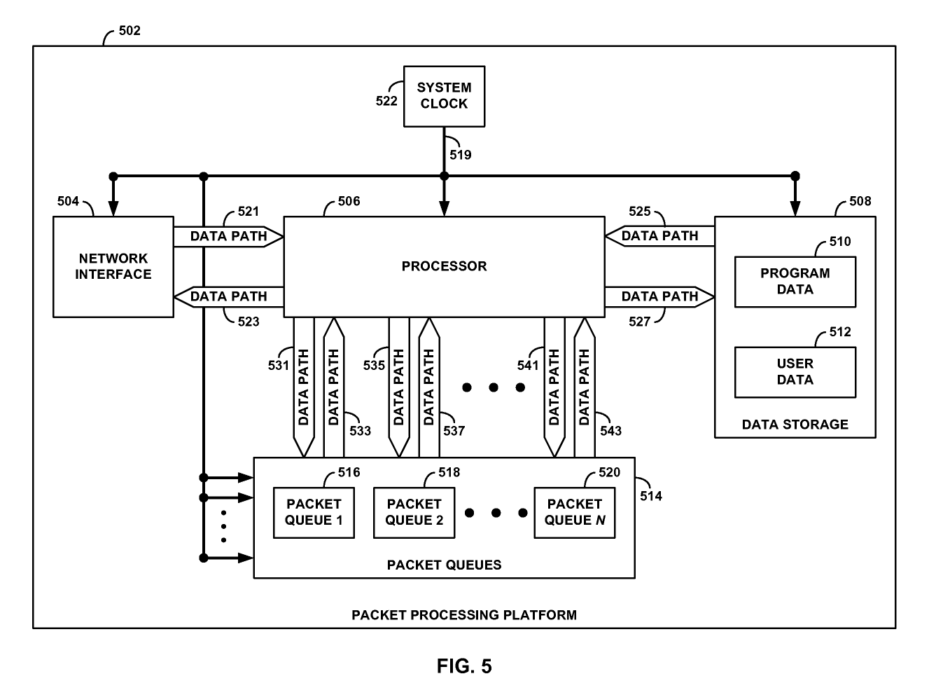

FIG. 5 shows a simplified representation of an embodiment of multiple DLPs in an FPGA implementation of a packet processing platform 502 that includes a network interface module 504, a processor block 506, data storage 508, packet queues 514, and system clock 522. As indicated, system clock 522 is connected to each of the other components via signal line 519, which may deliver a common signal, such as a clock tick, for example. Further, various components are communicatively connected by way of data paths, which represent physical pathways (e.g., wires) between components of the platform. There could be other components as well, and their omission from the figure should not be viewed as limiting with respect to the present invention.

Processor block 506 represents one or more sub-components, such as low-level logic blocks, gates, and additional interconnecting data paths. As such, processor block 506 could support the type of customization and/or specialization that is the basis for the speed and efficiency characteristic of FPGAs. In particular, processor block 506 may carry out operations related to packet processing, including IPS operations, content monitoring and analysis, and DPI, among others.

Network interface module 504 preferably supports connections to one or more types of packet networks, such as Ethernet or Wireless Ethernet (IEEE 802.11), and may comprise one or more input packet buffers for receiving network packets and one or more output packet buffers for transmitting network packets. Further, network interface module 504 may also include hardware, software, and firmware to implement one or more network protocol stacks to support packet communications to and from the interface.

Data storage 508, which could comprise some form of solid state memory, for example, includes program data 510 and user data 512. Program data 510 could comprise program variables, parameters and executable instructions, for instance, while user data 512 could comprise intermediate results applicable to a particular packet stream or communication connection. Other examples are possible as well.

Packet queues 514 comprise one or more individual queues 516, 518, and 520, representing packet queue 1, 2, and N, respectively. As indicated by the horizontal ellipses, there may be additional packet queues in between 2 and N, and the further no particular limitation is placed on N (other than it represents an integer). Being implemented as a distinct component, packet queues 514 may support packet queue buffering, as well as queuing functionality (e.g., FIFO operation), independently of any packet processing that may be performed by processing block 506. Thus, the goal of minimal impact of DLP delay on packet processing resources is achieved.

As indicated, network interface module 504 and processor block 506 are communicatively coupled via data paths 521 and 523, which transfer data, respectively, to and from the processor block (from and to the network interface). Similarly, data storage 508 and processor block 506 are communicatively coupled via data paths 525 and 527, which also transfer data, respectively, to and from the processor block (from and to data storage). Each of queues 516, 518, and 520 are also communicatively coupled with processor block 506 via data path pairs (531, 533), (535, 537) and (541, 543), respectively. Each data path pair transfers data packets to/from the respective packet queue from/to the processor block.

The common clock signal 519 may be used to drive and/or synchronize various functions of the platform components. Each packet queue may receive its own instance of the clock signal, as indicated by the horizontal arrows directed toward packet queues 514. Each queue may then use the signal to control a polling cycle. For instance, considering again the example of 12 queues and polling cycles (e.g., N=12), a common clock signal could be delivered to each queue every 9.7 μs, corresponding to the shortest polling cycle. Thus every clock signal would trigger the start of a polling cycle for the 12^{th} queue, every other clock signal for the 11^{th} queue, and so on up to 2,048 clock signals for the first queue (i.e., 20 ms polling cycle). Thus by counting clock signals, for instance, each queue could determine when its own polling cycle begins. In this way, the queuing operations associated with controlled DLP-based delay are further isolated from packet processing operations of processor block 506. Note that 9.7 μs is exemplary of a clock period, and others are possible as well.

In operation, packets will be received at packet processing platform 502 by network interface module 504, and will be transferred to processing block 506 via data path 521. If processing block 506 determines that a given packet needs to be delayed, for example because it arrived out of sequence, then a packet queue will be selected by matching a path delay to the desired delay for the packet, as described above (for example in connection with FIG. 4). The given packet will then be transferred to the selected queue via the appropriate data path. For example data path 531 for queue 516, data path 535 for queue 518, or data path 541 for queue 520. Once the given packet reaches the front of the queue in which it was placed, it will be returned to processor block 506 on the next polling cycle for that queue. As indicated, the return data paths for queues 516, 518, and 520 are data paths 533, 537, and 542, respectively. Upon return, the given packet may then be processed if its in-sequence counterpart arrived during its delay. Other actions are also possible, depending on the reason for the delay, the number of delays, or other factors discussed above.

The above description of an FPGA-based embodiment of multiple DLPs is exemplary, and details of FPGA operation and implementation have been simplified or omitted. It should be understood that any simplifications or omissions are not limiting with respect to the present invention.

### CONCLUSION

An exemplary embodiment of the present invention has been described above. Those skilled in the art will understand, however, that changes and modifications may be made to the embodiment described without departing from the true scope and spirit of the invention, which is defined by the claims.

What is claimed:

1. A method of introducing controlled delay in the processing of packets in a packet-switched data network, the method comprising:
determining that a packet should be delayed before being processed;
selecting a delay loop path (DLP) from a plurality of DLPs, the selection being made according to a desired delay value for the packet; and
sending the packet to the selected DLP.

2. The method of claim 1, wherein determining that the packet should be delayed comprises determining at least one property of the packet.

3. The method of claim 2, wherein selecting the DLP further comprises selecting the DLP based on the at least one property of the packet.

4. The method of claim 1, wherein determining that the packet should be delayed comprises determining that the packet is out of order with respect to at least one other packet in an ordered sequence.

5. The method of claim 1 further comprising determining the desired delay value according to a property of the packet, the property being selected from a group consisting of transport type, protocol type, application type, and sequence number.

6. The method of claim 1, wherein selecting the DLP further comprises:
determining a number of packets already in each of the plurality of DLPs; and
selecting the DLP in response to the number.

7. The method of claim 1, wherein sending the packet to the selected DLP comprises inserting the packet into a hardware first-in-first-out buffer.

8. The method of claim 1, wherein sending the packet to the selected DLP comprises placing the packet on a data path of a field-programmable gate array.

9. A method of introducing controlled delay in the processing of packets, the method comprising:
receiving a packet at a network entity;
determining that the packet should be subject to a delay before being processed;
determining a path delay for each of a plurality of delay loop paths (DLPs), the path delay for each respective DLP corresponding to a predicted time interval for any given packet entering the respective DLP to complete one circuit of the respective DLP and then exit the respective DLP;
selecting a delay loop path (DLP) from the plurality of DLPs, the selection being made according to a desired delay for the packet and the path delay for each respective DLP; and
sending the packet to the selected DLP.

10. The method of claim 9, wherein (i) each respective DLP of the plurality contains a number of packets, the number on each DLP incrementing by one when any one packet enters the respective DLP, decrementing by one when any one packet exits the respective DLP, and always being greater than or equal to zero, and (ii) the path delay determined for each respective DLP depends on at least the number of packets on the respective DLP, a loop delay for each respective DLP, and a service delay for each respective DLP, and wherein selecting the DLP further comprises:
selecting the DLP for which the path delay is closest in value to the desired delay.

11. The method of claim 10, wherein sending the packet to the selected DLP further comprises incrementing by one the number of packets on the selected DLP.

12. The method of claim 11, wherein determining that the packet should be delayed further comprises determining at least one property of the packet.

13. The method of claim 12, wherein selecting the DLP further comprises selecting the DLP based on the at least one property of the packet.

14. The method of claim 13, wherein determining the at least one property of the packet comprises determining both that the packet is one of a plurality of packets in an ordered sequence, and that the packet is out of order with respect to at least one other packet in the ordered sequence.

15. The method of claim 11, wherein receiving the packet at the network entity further comprises receiving the packet from a different network entity that is communicatively coupled to the network entity via the packet-switched network.

16. The method of claim 15, wherein (i) the loop delay for each respective DLP comprises a time interval for a single packet entering the respective DLP to complete one circuit of the respective DLP under the condition that prior to the single packet entering the respective DLP, the number of packets on the respective DLP is zero, and (ii) the service delay comprises a time interval for the single packet to exit the respective DLP, and wherein determining the path delay for each of the plurality of DLPs further comprises:
determining the number of packets on the respective DLP;
multiplying the number of packets by the loop delay to yield a current delay; and
adding the loop delay and the service delay to the current delay.

17. The method of claim 16, wherein each respective DLP of the plurality comprises a packet queue, and sending the packet to the selected DLP further comprises:
inserting the packet into the packet queue corresponding to the selected DLP; and
incrementing by one a counter of the number of packets in the packet queue corresponding to the selected DLP.

18. The method of claim 11, wherein receiving the packet at the network entity further comprises:
receiving the packet from a DLP upon exit from the DLP; and
decrementing by one the number of packets on the DLP from which the given packet exited.

19. The method of claim 18, wherein (i) the loop delay for each respective DLP comprises a time interval for a single packet entering the respective DLP to complete one circuit of the respective DLP under the condition that prior to the single packet entering the respective DLP, the number of packets on the respective DLP is zero, and (ii) the service delay comprises a time interval for the single packet to exit the respective DLP, and wherein determining the path delay for each of the plurality of DLPs further comprises:
determining the number of packets on the respective DLP;
multiplying the number of packets by the loop delay to yield a current delay; and
adding the loop delay and the service delay to the current delay.

20. The method of claim 19, wherein each respective DLP of the plurality comprises a packet queue, and sending the packet to the selected DLP further comprises:
inserting the packet into the packet queue corresponding to the selected DLP; and
incrementing by one a counter of the number of packets in the packet queue corresponding to the selected DLP.

21. The method of claim 20, wherein receiving the packet from the DLP upon exit from the DLP further comprises:
receiving the packet from the packet queue corresponding to the DLP from which the packet exited; and
decrementing by one the counter of the number of packets in the packet queue corresponding to the DLP from which the packet exited.

22. The method of claim 21, wherein the loop delay for each respective DLP comprises to a polling cycle for the queue corresponding to the respective DLP, the service delay for each respective DLP comprises the time interval for removing any given packet from the queue corresponding to the respective DLP, and receiving the packet from the packet queue further comprises:
finding the packet during the polling cycle for the queue from which the packet is received; and
removing the packet from the packet queue in which it is found.

23. A system for introducing controlled delay in the processing of packets in a packet-switched network, the system comprising:
a processor;
a network interface;
a plurality of delay loop paths (DLPs);
data storage; and
machine language instructions stored in the data storage and executable by the processor to:
receive a packet via the network interface;
determine that the packet should be delayed before processing;
determine a path delay for each of the plurality of DLPs, the path delay for each respective DLP corresponding to a predicted time interval for any given packet entering the respective DLP to complete one circuit of the respective DLP and then exit the respective DLP;
select a delay loop path (DLP) from the plurality of DLPs according to a desired-delay value for the packet and the path delay for each respective DLP;
send the packet to the selected DLP; and
receive the packet from the selected DLP.

24. The system of claim 23, wherein the machine language instructions stored in the data storage are further executable by the processor to:
determine that the packet is one of a plurality of packets in an ordered sequence, and that the packet was received out of order with respect to at least one other packet in the ordered sequence; and
determine the desired-delay value based on the determination that the packet was received out of order.

25. The system of claim 23, wherein each of the processor, the network interface, the plurality of DLPs, and the data storage is a component of a field-programmable gate array (FPGA), and wherein each of the processor, the network interface, the plurality of DLPs, and the data storage comprises one or more sub-elements of the FPGA.

26. The system of claim 25, wherein each DLP of the plurality further comprises packet storage in the form of a packet queue corresponding to the respective DLP, each respective packet queue being arranged to contain a number of packets, the number incrementing by one when any one packet is added to the respective packet queue, decrementing by one when any one packet is removed from the respective packet queue, and always being greater than or equal to zero.

27. The system of claim 26, wherein the machine language instructions stored in the data storage are further executable by the processor to:
determine a path delay for each of the plurality of DLPs by computing for each respective packet queue a calculated queuing delay according to (i) a polling cycle for the respective packet queue, (ii) the number of packets in the respective packet queue, and (iii) a service time, the service time being the time interval for removing any given packet from the respective queue; and
select a DLP according to the desired-delay value and the path delay for each respective DLP by identifying a packet queue for which the calculated queuing delay is closest in value to the desired-delay value, and selecting the DLP corresponding to the identified packet queue.

28. The system of claim 27, wherein the machine language instructions stored in the data storage are further executable by the processor to send the packet to the selected DLP by adding the packet to the packet queue corresponding to the selected DLP, and by responsively incrementing by one a counter of the number of packets in the packet queue corresponding the selected DLP.

29. The system of claim 28, wherein the machine language instructions stored in the data storage are further executable by the processor to:
examine each respective packet queue according to the polling cycle for the respective packet queue; and
remove a packet from the respective packet queue if there is at least one packet in the respective packet queue when the respective packet queue is examined, and responsively decrement by one the counter of the number of packets in the respective packet queue.

30. The system of claim 29, wherein the machine language instructions stored in the data storage are further executable by the processor to receive the packet from the selected DLP by removing the packet from the respective packet queue corresponding to the selected DLP during the polling cycle for the respective packet queue.

31. The system of claim 27, wherein upon being added to the identified packet queue, the packet will remain in the identified packet queue for a time period in a range from one polling cycle plus the service time for the identified queue to a number of polling cycles plus the service for the identified queue, the number of polling cycles being one greater than the number of packets in the identified queue when the packet is added to the identified queue.
